(19) United States
(12) Patent Application Publication
(10) Pub. No.: US 2010/0091773 A1
(43) Pub. Date: Apr. 15, 2010

(54) SYSTEM AND METHOD FOR IDENTIFYING NETWORK-CONNECTED USER

(75) Inventors: Ming-Shan Shyu, Taipei (TW); Yuan-Ting Hsu, Taipei (TW); Ching-Keui Chang, Taipei (TW); Feng-Peng Yu, Taipei (TW); I-Fang Wu, Taipei (TW)

Correspondence Address: EDWARDS ANGELL PALMER & DODGE LLP, P.O. BOX 55874, BOSTON, MA, 02205, US

(73) Assignee: CHUNGHWA TELECOM CO., LTD., Taipei (TW)

(21) Appl. No.: 12/543,948

(22) Filed: Aug. 19, 2009

(30) Foreign Application Priority Data
Oct. 14, 2008 (TW) 097139308

(51) Int. Cl. H04L 12/56; G06F 15/16; G06F 11/00

(52) U.S. Cl. 370/392; 709/229; 726/24

(57) ABSTRACT

A system and method for identifying a network-connected user are disclosed. The method includes connecting a user end device to a routing device and guiding the user end device to a specific routing path by the routing device according to a programmed file of the user end device, thereby overcoming the drawbacks of prior techniques in which routing devices configured by ISPs can only forward data packets based on IP addresses and a routing table, being unable to make routing orientations according to characteristics of the data packets. The present invention facilitates management of data packets of specific network users and can provide more flexible combinations of service content.

### BACKGROUND OF THE INVENTION

1. Field of the Invention

The present invention relates generally to a system and a method for identifying network-connected users, and more particularly, to a system and method for identifying network user services and accordingly guiding data packets of network users to specific routing paths.

2. Description of Related Art

Network and Internet access is becoming ubiquitous. Users can conduct various activities through networks and the Internet, for example, searching, browsing, shopping or chatting.

Generally, users access the Internet through Internet Service Providers (ISPs), which are companies or organizations offering Internet access and network services to users. These entities buy connection equipment and rent lines and bandwidth to provide service to users. Generally, users access the Internet through routing devices provided by ISPs.

However, as network activity becomes much more diverse, many atypical network connection activities cannot be handled through only the routing devices of ISPs, but must also be handled with assistance of specific service systems.

Referring to FIG. 1, a block diagram of a conventional IP-based network packet transmission system is shown, wherein an A-user end device 10a, a B-user end device 10b and a C-user end device 10c connect to a service providing device 12 through a routing device 11, and, after the service providing device 12 identifies the users and provides specific services, the user end devices are connected to Internet 13. However, such a destination IP-based packet transmission mechanism cannot guide routing paths according to characteristics of packets. Moreover, since all the end user devices need to pass through the service providing device 12 that determines what kind of services should be provided to the user end devices, an overload problem may easily occur at the service providing device 12.

Therefore, it has become highly desirable to find a way to identify users that apply for network access or service and provide a corresponding guiding process so as to distribute and manage the data packets of specific users.

### SUMMARY OF THE INVENTION

According to the above drawbacks, an objective of the present invention is to provide a system and a method for identifying network-connected user so as to identify users and guide user end devices to specific services.

In order to attain the above and other objectives, the present invention provides a system for identifying a network-connected user, which comprises: a user end device; a routing device for providing a routing path to the user end device; and a service providing device for providing specific services to the user end device, wherein the routing device guides the user end device to the service providing device according to a programmed file of the user end device.

In a preferred embodiment, the system further comprises a provision server for providing the programmed file corresponding to the user end device to the routing device.

According to another embodiment, the service comprises anti-virus, virus scanning, malicious packet blocking, malicious connection blocking and/or web page filtering services.

A method for identifying a network-connected user of the present invention comprises the following steps: (1) connecting a user end device to a routing device; and (2) guiding the user end device to a specific service providing device by the routing device according to a programmed file of the user end device.

According to a preferred embodiment, step (1) further comprises: (1-1) providing the programmed file corresponding to the user end device to the routing device by a provision server; and (1-2) connecting the user end device to the routing device. Compared with the prior art, the present invention identifies specific network users according to programmed files generated when the users applies for provision of services. Once the specific network users are network-connected, the access router guides data packets of the users to appropriate routing paths or service providing devices according to the programmed files, thereby facilitating distribution and management of data packets by ISPs.

### BRIEF DESCRIPTION OF DRAWINGS

FIG. 1 is a block diagram showing an IP-based network packet transmission system;

FIG. 2 is a block diagram showing a system for identifying a network-connected user according to the present invention;

FIG. 3 is a block diagram showing a system for identifying a network-connected user according to an embodiment of the present invention;

FIG. 4 is a block diagram showing a system for identifying a network-connected user according to another embodiment of the present invention;

FIG. 5 is a flow diagram showing a method for identifying a network-connected user according to the present invention; and

FIG. 6 is a flow diagram showing a method for identifying a network-connected user according to an embodiment of the present invention.

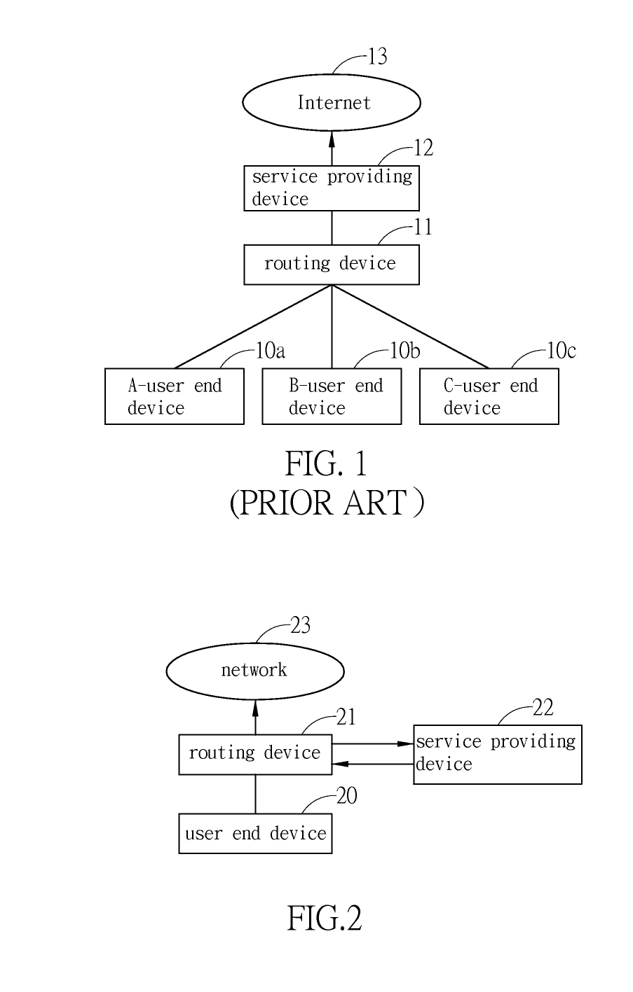

### DETAILED DESCRIPTION OF PREFERRED EMBODIMENTS

The following illustrative embodiments are provided to illustrate the disclosure of the present invention; these and other advantages and effects will be apparent to those skilled in the art after reading the disclosure of this specification.

FIG. 2 is a block diagram showing a system for identifying a network-connected user according to the present invention. As shown in the drawing, the system of the present invention comprises a user end device 20, a routing device 21, a service providing device 22 and a network 23.

The user end device 20 is an electronic device capable of accessing data and performing data processing such as a workstation, a desktop computer, a notebook computer, a digital TV device, a personal digital assistant and/or a mobile phone.

The routing device 21 provides a routing path to the user end device 21. The routing device 21 is a device that transmits data between networks, determining a data transmission path. Data over the network is divided into a plurality of data packets, based on the destination of the data packets, wherein the routing device 21 routes the packets over the best route available at the time. Therefore, when the user end device 20 uploads or receives data packets, the routing device 21 can guide the data packets to specific routers or servers.

The service providing device 22 provides various service contents to the user end device 20, such as anti-virus, virus scanning, malicious packet blocking, malicious connection blocking and/or web page filtering services.

In an embodiment of the invention, the user end device 20 is first connected to the routing device 21 and then the routing device 21 generates routing path according to a programmed file of the user end device 20. When the user end device 20 uploads data packets, the routing device 21 guides the data packets to a specific routing path based on a policy-based routing (PBR) technique such that the data packets can be transmitted to the predetermined service providing device 22 for providing various services. Finally, the data packets are transmitted to the network 23 through the routing device 21. The content of the programmed file is based on the PBR technique and is created when the user end applies for network service. It should be noted that the routing device 21 and the programmed file are not limited to the PBR technique. Other communication protocol techniques that can identify a connection request on the user end and guide the request to specific routing can be used.

In a preferred embodiment, the user end device connects to the routing device through a wide area network (WAN) system, a virtual private network (VPN) system, a local area network (LAN) system and/or a wireless network.

In another preferred embodiment of the invention, the system for identifying a network-connected user comprises a provision server for providing the programmed file of the user end device to the routing device.

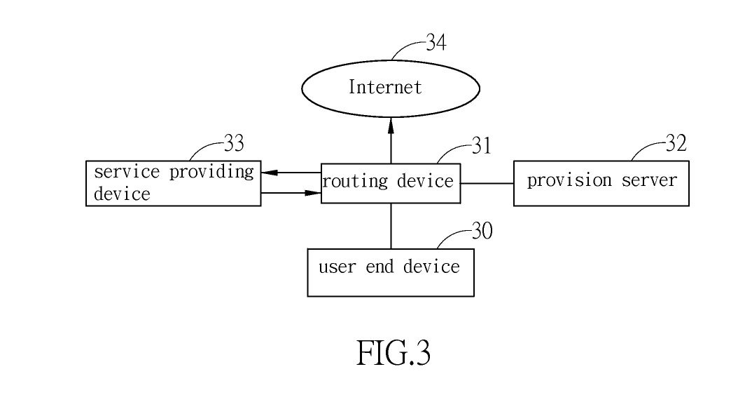

FIG. 3 is a block diagram showing a system for identifying a network-connected user according to an embodiment of the present invention. The system of the present embodiment comprises a user end device 30, a routing device 31, a provision server 32, a service providing device 33 and the Internet 34. The operation of the system is detailed as follows.

The user end device 30 is connected to the routing device 31 for transmission of data packets to the Internet 34. When the user end device 30 applies to an Internet service provider for provision of network service, the Internet service provider creates a programmed file corresponding to the user end device 30. In the present embodiment, the Internet service provider stores the programmed file in the provision server 32 that further provides the programmed file to the routing device 31. When data packets are transmitted from the user end device 30 to the routing device 31, the routing device 31 guides the data packets to the service providing device 33 according to the programmed file for providing service content. Thereafter, the data packets are transmitted back to the routing device 31 and further transmitted to the Internet 34. Similarly, data packets from the Internet 34 are guided to the user end device 30 through the same path by the routing device 31. Therefore, the present invention can conveniently distribute and manage data packets of network users and solve the overload problem of service providing devices that exists in the prior art.

In a preferred embodiment, the routing device 31 can provide a plurality of routing paths according to different programmed files so as to efficiently manage the upload and download of data packets.

In another preferred embodiment, the programmed file of the user end device 30 stored in the provision server 32 comprises provision data, wherein such provision data can include the connection method and/or type of application service of the user end device 30.

It should be noted that different programmed files generated according to different application content of network users can be stored in the provision server 32 or the routing device 31, or stored in a storage device such as a hard disk such that, when the routing device 31 receives connection request of a network user, the routing device 31 can guide the connection path of the user to a specific routing path according to the programmed file corresponding to the user.

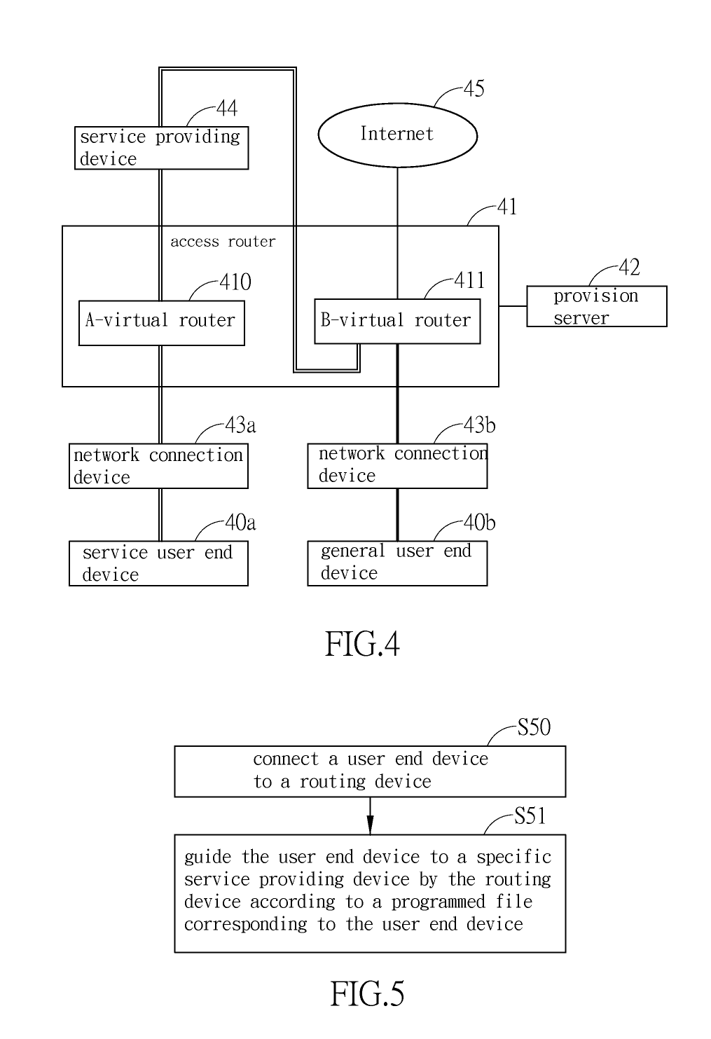

FIG. 4 is a block diagram showing a system for identifying a network-connected user according to another embodiment of the present invention. The system of the present embodiment comprises a service user end device 40a, a general user end device 40b, an access router 41, a provision server 42, network connection devices 43a, 43b, a service providing device 44, and the Internet 45.

The service user end device 40a applies to the Internet service provider for Internet access and a specific network service function, while the general user end device 40b only applies for Internet access. Therefore, two programmed files are generated according to the different application contents of the user end devices such that the access router 41 can guide data packets to different routing paths.

In an embodiment, the general user end device 40b connects to the access router 41 through the network connection device 43b. The access router 41 is divided into an A-virtual router 410 and a B-virtual router 411. As the general user end device 40b applies for network access, when data packets enter into the access router 41, the B-virtual router 411 guides the data packets to the Internet 45. Similarly, data packets from the Internet 45 are transmitted to the general user end device 40b through the B-virtual router 411 of the access router 41.

When the service user end device 40a connects to the access router 41 through the network connection device 43a, the A-virtual router 410 guides data packets from the service user end device 40a to the service providing device 44. After being processed by the service providing device 44, the data packets are transmitted to the B-virtual router 411 which further guides the data packets to the Internet 45. Similarly, data packets from the Internet 45 to be transmitted to the service user end device 40a are transmitted through the same routing path. That is, the data packets are first processed by the service providing device 44 and then transmitted to the user end device 40a through the A-virtual router 410.

Therefore, different programmed files are generated according to different application content of network users. According to the programmed files, the access router 41 can determine different packet transmission paths. Data packets from the service user end device 40a are first transmitted to the A-virtual router 410, and then transmitted to the service providing device 44, and subsequently transmitted to the B-virtual router 411 and further transmitted to the Internet 45, thereby making the data packets of the service user end device 40a managed by the service providing device 44. The present invention transmits upload and download data packets of different user end devices through different routing paths, thereby providing more flexible network service combinations.

FIG. 5 is a flow diagram of a method for identifying a network-connected user according to the present invention.

First, at step S50, a user end device is connected to a routing device, wherein the user end device is connected to the routing device through a wide area network (WAN) system, a virtual private network (VPN) system, a local area network (LAN) system and/or a wireless network. The user end device can be a workstation, a desktop computer, a notebook computer, a personal digital assistant and/or a mobile phone.

In a preferred embodiment, step S50 further comprises: step S501, wherein a provision server provides a programmed file corresponding to the user end device to the routing device; and step S502, wherein the user end device is connected to the routing device.

At step S51, the routing device guides the user end device to a specific service providing device according to the programmed file corresponding to the user end device so as to analyze or manage data packets.

In a preferred embodiment, the routing device provides a plurality of routing paths according to different programmed files.

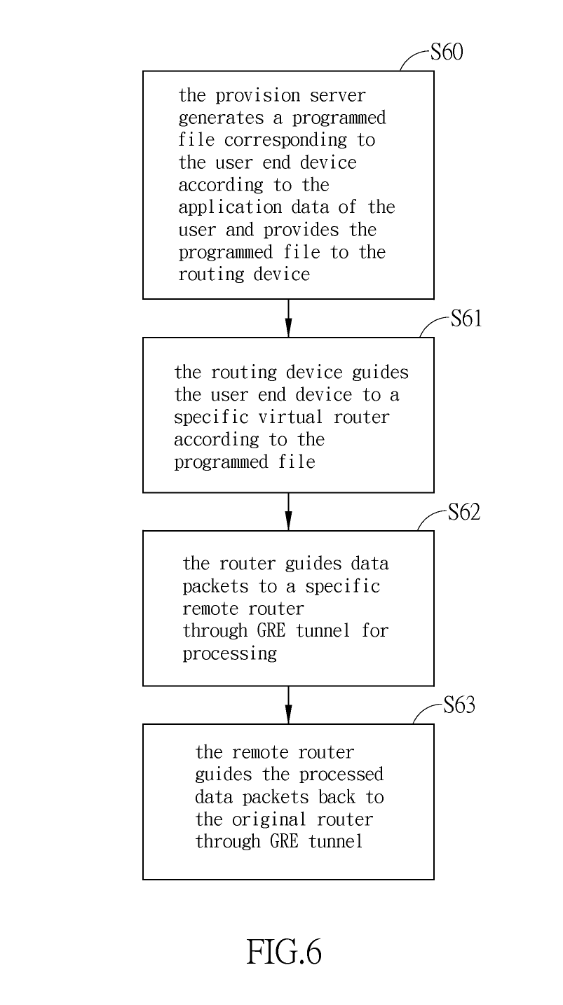

FIG. 6 is a flow diagram showing a method for identifying a network-connected user according to an embodiment of the present invention.

At step S60, a provision server generates a programmed file corresponding to a user end device according to the application data of the user and provides the programmed file to a routing device. Then, the process goes to step S61.

At step S61, the routing device guides the user end device to a specific virtual router according to the programmed file corresponding to the user end device. Then, the process goes to step S62.

At step S62, the virtual router guides data packets to a specific remote router through the technique of using a Generic Routing Encapsulation (GRE) tunnel for processing, the GRE technique being known in the art. Then, the process goes to step S63.

At step S63, the remote router guides the processed data packets to the original router through the GRE tunnel.

Through such a method, an Internet service provider can rapidly guide data packets of specific user to a remote router through the GRE tunnel for processing and then transmit the processed data packets back to the original access router. Through the GRE tunnel, the Internet service provider does not need to provide additional service equipment for users at different regions or remote regions, thereby saving costs. However, note that the current invention is not limited to use of the GRE tunnel.

According to the present invention, access routers determine routing paths according to programmed files corresponding to the services to be provided to users. The access routers can predetermine a plurality of routing paths directing to different services. Therefore, data packets of each network user are guided to a specific service providing device through the corresponding routing path. As a result, the present invention can manage the transmission packets of specific network users and provide more flexible combinations of service content.

Therefore, the system and method for identifying a network-connected user of the present invention have the following effects:
(1) facilitating easier Internet access for users since user identification and packet distribution are performed according to programmed files without the need of additional operation of the users.
(2) reducing costs by establishing security protection mechanisms at the user end since ISPs can manage and protect data packets and users do not need additional security protection mechanisms such as firewall equipment or anti-virus software.

The above-described descriptions of the detailed embodiments are provided to illustrate the preferred implementation according to the present invention, and are not intended to limit the scope of the present invention. Accordingly, many modifications and variations completed by those with ordinary skill in the art can be made and yet still fall within the scope of present invention as defined by the appended claims.

What is claimed is:

1. A system for identifying a network-connected user, comprising:
a user end device;
a routing device for providing a routing path to the user end device; and
a service providing device for providing specific services to the user end device, wherein the routing device guides data transmission of the user end device to the service providing device according to a programmed file of the user end device.

2. The system of claim 1, further comprising a provision server for providing the programmed file corresponding to the user end device to the routing device.

3. The system of claim 1, wherein the user end device connects to the routing device through a wide area network (WAN) system, a virtual private network (VPN) system, a local area network (LAN) system and/or a wireless network.

4. The system of claim 1, wherein the user end device is a workstation, a desktop computer, a notebook computer, a personal digital assistant and/or a mobile phone.

5. The system of claim 1, wherein the routing device provides a plurality of routing paths according to different programmed files of user end devices.

6. The system of claim 5, wherein the user end devices transmit data packets through the routing paths.

7. The system of claim 1, wherein the programmed file further comprises provision data of the user end device, and the provision data comprises the connection method and/or type of application service of the user end device.

8. The system of claim 1, wherein the service provided by the service provision device comprises anti-virus filtering, virus scanning, malicious packet blocking, malicious connection blocking and/or web page filtering.

9. A method for identifying a network-connected user, comprising the following steps:
(1) connecting a user end device to a routing device; and
(2) guiding the data transmission of the user end device to a specific service providing device by the routing device according to a programmed file of the user end device.

10. The method of claim 9, wherein step (1) further comprises:
(1-1) providing the programmed file corresponding to the user end device to the routing device by a provision server; and
(1-2) connecting the user end device to the routing device.

11. The method of claim 9, wherein the user end device connects to the routing device through a wide area network (WAN) system, a virtual private network (VPN) system, a local area network (LAN) system and/or a wireless network.

12. The method of claim 9, wherein the user end device is a workstation, a desktop computer, a notebook computer, a personal digital assistant and/or a mobile phone.

13. The method of claim 9, wherein the routing device provides a plurality of routing paths according to different programmed files.

14. The method of claim 9, wherein the routing device connects the service providing device, and step (2) further comprises a step of guiding the data packets of the user end device to a remote routing device by the routing device.

15. The method of claim 14, wherein step (2) further comprises guiding the data packets of the user end device to the remote routing device by the routing device through a Generic Routing Encapsulation (GRE) tunnel.
